(19) United States
(12) Patent Application Publication
(10) Pub. No.: US 2013/0185159 A1
(43) Pub. Date: Jul. 18, 2013

(54) SYSTEM AND METHODS FOR MARKETING COMMUNICATIONS AND PROMOTION AUTOMATION

(71) Applicant: David CRANE, Centerport, NY (US)

(72) Inventor: David CRANE, Centerport, NY (US)

(21) Appl. No.: 13/743,883

(22) Filed: Jan. 17, 2013

Related U.S. Application Data
(60) Provisional application No. 61/587,527, filed on Jan. 17, 2012.

(51) Int. Cl. G06Q 30/02

(52) U.S. Cl. CPC G06Q 30/0269
USPC 705/14.66

(57) ABSTRACT

A system for integrating customer databases, the system including a merchant database received from a first merchant, the merchant database including a plurality of individual customer entries, a database provided by a promoter, an integration engine for integrating the merchant database with the promoter database, a promotion engine configured to obtain additional information relating to each of the plurality of individual customer entries and an extraction engine configured to extract an extraction database from the promoter database. The integration engine is configured to maintain a differentiation between the merchant database and the promoter database. The extraction database includes the merchant database and the additional information related to each of the plurality of individual customer entries obtained by the promotion engine.

### CROSS REFERENCE TO RELATED APPLICATION

The present application claims the benefit of and priority to U.S. Provisional Patent Application. No. 61/587,527, filed on Jan. 17, 2012, by David Crane, entitled “SYSTEM AND METHOD FOR MARKETING COMMUNICATIONS AND PROMOTION AUTOMATION”, the entire contents of which being incorporated by reference herein.

### BACKGROUND

1. Technical Field

The present invention relates to systems and methods for providing marketing communication and promotion automation between merchant, merchant's customers, a promoter's members and potential customer and/or members wherein the system and methods include the importation and/or integration of a merchant's customer database, mapping of the customer database to the promoter member database, linking of the promoter member database and entries of the merchant's client database and the facilitation and/or generation of communication and/or promotion between one or more merchants and one or more of the promoter's members or the promoter's potential members.

2. Description of Related Art

In this new age of electronic communication and social media, effective product marketing, branding and promotions require multiple avenues to effectively generate business from existing business relationships and to effectively generate new business relationships, connections and advertisements. Marketing, branding and promotion require effective use of social and media services such as social networks, e-newsletters, blogs, discussion forums, micro-publication tools, surveys and opinion forums, coupon generation and distribution, loyalty recognition and rewards, social media integration, direct electronic communications (e.g., e-mail and text messaging) business-buyer communities, event generation communities, virtual community interface, database building, mobile communication and promotion automation.

As electronic communication and virtual connections grow and evolve, it becomes increasingly difficult and/or expensive for merchants to maintain a current and effective virtual presence. For example, two social media destinations, Facebook® and MySpace®, launched in 2003 and 2004, respectively. MySpace® became the most popular social media and by 2006 exceeded 50 million active users. In comparison, Facebook® did not exceed over 50 million active until 2007. Since 2008, the social media landscape has demonstrated rapid expansion, evolution and change with Facebook® rising from 100 million active users in 2008 to 800 million active users in 2012 while MySpace® maintaining only 100 million active users. More significantly, new social media websites demonstrated rapid growth, expansion and early adoption with Google+® generating 50 million users in only 3 months, Twitter® generating 300 million active users since 2006 and LinkedIn®, a business-related social networking site, generating over 120 million registered users.

In addition to the rapidly changing social media landscape, so changes the demographics of each individual social media website over time. For example, Facebook® was initially available to college students and an age demographic that was primarily between 18 and 24 years old. The age demographic of Facebook® shifted dramatically to an older demographic when the student restriction was eliminated.

In addition to social media, businesses must also consider the various ecommerce platforms (e.g., social advertisement, social discounting, social purchasing and/or deal-of-the day sales). This market segment includes new entries such as Groupon®, LivingSocial®, BuyWithMe and Teambuy and expanded offers from established merchants such as Amazon®, Buy.com®, and Newegg®.

Deal-of-the-day sales, also appropriately named flash sales, pose additional risks for small to medium sized merchants, especially merchants with a limited geographical region and/or businesses with a limited ability to ramp-up production or services for short-term surges typically generated by deal-of-the-day type sales. For example, deal-a-day advertisement can often result in a short-term surge in business that cannot be sufficiently absorbed by the merchant with current resources and as a result, the increase in business may result in an overall loss of business due to general dissatisfaction with the transactions and/or interaction with the merchant. As such, merchants must draw a balance between “too much” advertising and “to little” advertising.

As such, there is a need for an individual web-based marketing service that provides a single web-based marketing point-of-contact for the merchant that allows selective targeting and control the advertisement to coincide with current resources and business needs.

### SUMMARY

The present disclosure relates to a systems and methods for integrating customer databases and promoting merchants and merchant's products and/or services.

According to a system of the present disclosure, a system for integrating customer databases includes a merchant database received from a first merchant and including a plurality of individual customer entries, a database provided by a promoter, an integration engine for integrating the merchant database with the promoter database, a promotion engine configured to obtain additional information relating to each of the plurality of individual customer entries and an extraction engine configured to extract an extraction database from the promoter database. The integration engine is configured to maintain a differentiation between the merchant database and the promoter database. The extraction database includes the merchant database and the additional information related to each of the plurality of individual customer entries obtained by the promotion engine.

The promotion engine generates a plurality of individual customer entries in the promoter database, wherein at least one of the plurality of individual customer entries includes information related to data provided in the merchant database.

The integration engine differentiates between information contained in the merchant database and each of the plurality of individual customer entries in the database provided by the promoter.

The promotion engine is configured to generate electronic invitations from data contained in the merchant database. Invitations invite each of the plurality of individual customer entries to accept the invitation and join the database provided by the promoter.

According to a method of the present disclosure, a method for integrating customer databases includes the steps of: providing a database from a promoter including a plurality member records; providing a first merchant database and a second merchant database, wherein each of the first and second merchant databases includes a plurality of customer entries; integrating the first merchant database and the second merchant database with the promoter database while maintaining the individual integrity of promoter database and the first and second merchant databases; obtaining information related to at least one of the plurality of customer entries in the first merchant database; and extracting an extraction database from the promoter database wherein the extraction database includes the first merchant database and at least a portion of the obtained information.

According to another method of the present disclosure, a method of automatically generating promotions includes the steps of: providing a promoter database including a plurality of member records; defining a trigger for automatically generating promotions; defining at least a portion of the plurality of member records for receiving the promotion; determining when the trigger occurs; and sending the promotion to the defined portion of the plurality of member records. The trigger may be a specific, yet currently unknown, event, selected from an event related to weather, an event related to the outcome of a sports competition, an event related to the outcome of a political event, an event related to an entertainment event and an event related to a financial condition or any other event where the outcome will be available in a database to act as a trigger.

The trigger may be related to an outcome of a specific event, wherein content of the promotion is a function of the outcome of the specific event. The specific event may be a weather event, a sports competition, a political event, an entertainment event and/or a financial event.

A system for generating promotional materials includes a database provided by a promoter, a promoter portal and a promotion engine. The database includes a merchant database received from a first merchant and including a plurality of individual customer entries, a plurality of member database entries; and a plurality of links defining common information contained in the plurality of individual customer entries and the plurality of member database entries. The promoter portal is utilized to generate promotional material, define criteria for selecting recipients wherein the recipients are selected from the plurality of member database entries, and for defining a trigger for releasing the promotion material. The promotion engine is configured to determine when the trigger has occurred and, upon occurrence of the trigger, sends the promotional material to the selected recipients.

The trigger may be related to an outcome of a specific event. The content of the promotion may be a function of the outcome of the specific event. The criteria for selecting recipients may be a function of the outcome of the specific event. The specific event may be a weather event, a sporting event, a political event, an entertainment event and a financial event.

### BRIEF DESCRIPTION OF THE DRAWINGS

Various aspects of the present disclosure are described hereinbelow with reference to the drawings, wherein:

FIG. 1 is a block diagram depicting a plurality of merchants with individually maintained customer databases and connections to a sample of their existing customers;

FIG. 2 is a block diagram depicting the introduction of a promoter according to one embodiment of the present disclosure;

FIG. 3 is a flow chart depicting data collection according to one embodiment of the present disclosure and the ownership and linking of data between the promoter database and the client database;

FIG. 4 is a flow chart depicting member data collection by the promoter and linking of the member data to merchants; and

FIG. 5 is a flow chart depicting client database tracking with respect to the promoter member database.

### DETAILED DESCRIPTION

Detailed embodiments of the present disclosure are described herein; however, it is to be understood that the disclosed embodiments are merely exemplary and may be embodied in various forms. Therefore, systems and methods disclosed herein are not to be interpreted as limiting, but merely as a basis for the claims and as a representative basis for teaching one skilled in the art to employ the present disclosure.

For the purposes of this application, the parties involved in the various systems and methods described herein include merchants, a promoter and consumers. A merchant is a provider of goods and/or services to consumers. Goods or services may include actual goods or products, virtual goods or products, actual services, virtual services, information and/or advertisements. The promoter is an interfacing entity that maintains a delimitation and classification between each merchant customer database, the promoter member database and the individual members.

Consumers are defined as individuals, individual entity or companies that purchase goods from merchants and/or contract with merchants for services. In this application, consumers may be classified as a merchant's customers or a merchant's clients, based on the type of relationship formed between the merchant and the consumer. Consumers may also be classified as members or potential members based on the relationship (or potential relationship) between the consumer and the promoter. Goods or services may include actual goods or products, virtual goods or products, actual services, virtual services, information and/or advertisements.

The promoter controls and maintains the classification of each consumer (as a member, customer and/or client). The promoter controls the integration (or partial integration) of the merchant databases and the promoter member database and/or potential members contained therein. The promoter provides a portal for controlling the interaction between merchants, the members of the promoter member database and/or the potential members contained therein. The promoter controls the interaction between any two or more merchants. Finally, the promoter performs ongoing data collection, data correction and data integration of the merchant database, the client and customer databases and the promoter member database.

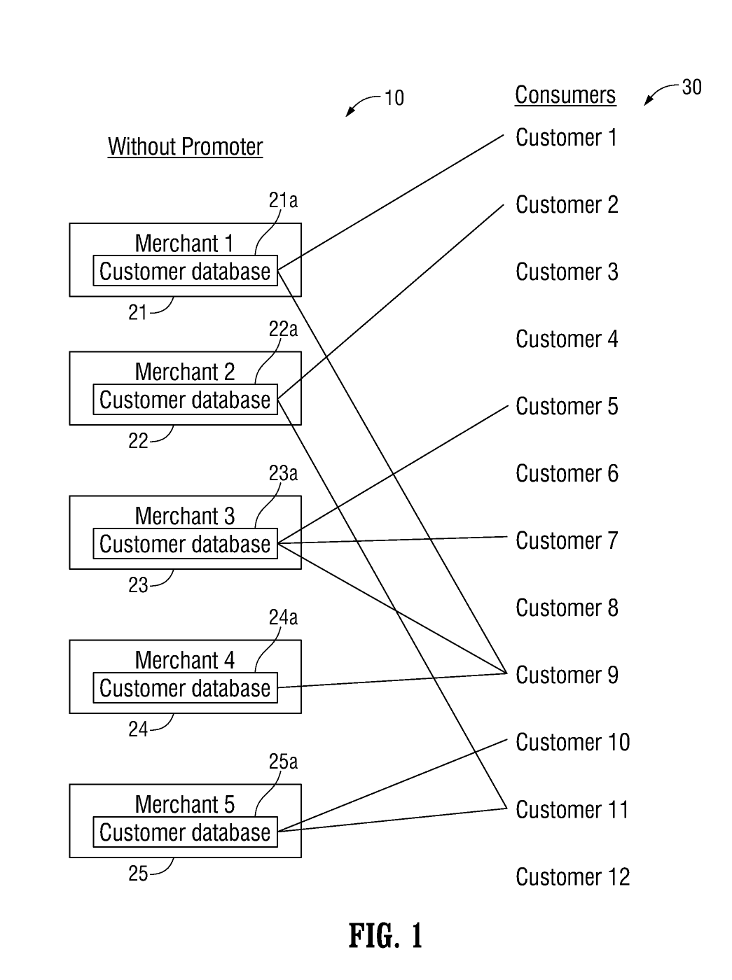

Referring now to FIG. 1, a block diagram depicting a plurality of merchants 21-25 with individually maintained customer databases 21a-25a and connections to a sample of their existing customers 30 is shown as 10. Merchants 21-25 each maintain a customer database 21a-25a with each database entry containing information related to existing customers and/or entries containing information related to potential customer, as indicated by the lines connecting customers 30 to customer databases 21a-25-a. In the sample provided, Merchant1 21 includes database entries for Customer1 and Customer9 with each database entry including information obtained during a past interaction between the Merchant1 and Customer1 and Customer9.

The classic model illustrated in FIG. 1, provides many challenges for merchants 21-25. The first challenge is that updates in customer databases 21a-25a are performed when a new interaction occurs between one of the merchants 21-25 and a specific customer 30. As such, information in the customer database 21a-25a may become out-of-date if the time between transactions and/or interactions is an extended amount of time. The second challenge is that with this model, new transactions between customers 30 are typically performed during the sale of goods or while performing services. The primary purpose of this transaction is sales/services and updating the customer's information is often overlooked and/or not performed. Additionally, customers 30 are often reluctant to provide information (or accurate information) during a purchase and even more reluctant to provide sensitive information (e.g., annual income ranges, number of children, home ownership, etc. . . . ) during this type of interaction.

Yet another challenge is that while merchants 21-25 may be very successful in business, they typically do not dedicate sufficient resources (time and money) to maintain their customer database 21a-25a. As such, the information contained therein is often inaccurate and, as a result, underutilized.

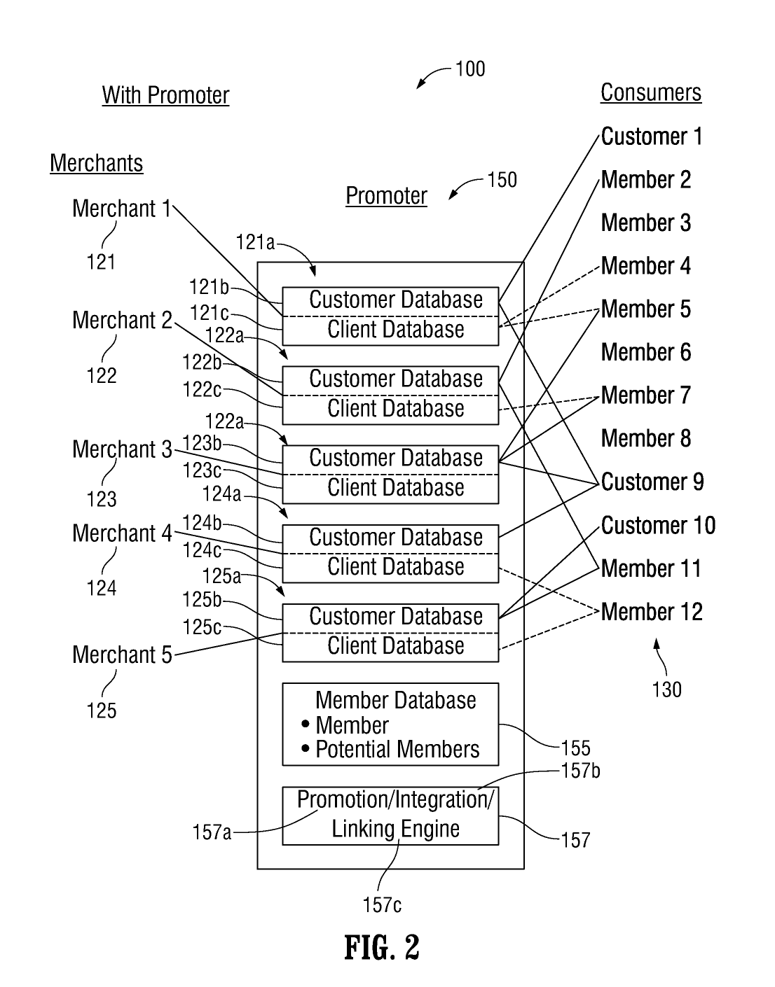

Referring now to FIG. 2, a block diagram depicting the introduction of a promoter 150 according to one embodiment of the present disclosure, is shown as 100. Promoter 150 maintains a merchant database 121a-125a for each merchant 121-125, respectively, wherein each merchant database 121a-125a and the information contained therein, are owned by, and includes information specifically related to, the respective merchant 121-125, as will be discussed in detail hereinbelow.

As defined herein, a “customer 130” has a relationship with the merchant formed without the aid of the promoter 150. A member has a relationship (e.g., membership, subscription, agreement, etc. . . . ) with the promoter 150 and may also have a relationship with one or more merchants 121-125 through the promoter 150. As such, a consumer 130 may be a “customer” and a “member” (e.g., relationship formed with the merchant 121-125 without the aid of the promoter 150 and a membership with the promoter 150).

As defined herein, a “client” is a member that forms a relationship with a merchant 121-125 through the aid of the promoter 150. A consumer 130 may form a “customer” relationship with a merchant 121-125 (formed without the aid of the promoter 150) or a “client” relationship with a merchant 121-125 (formed with the aid of the promoter 150). As such, each customer database 121a-125a includes database entries of consumers 130 that have a relationship with the respective merchant 121-125. If the relationship was formed without the aid of the promoter 150, the consumer 130 is the merchant's “customer”. If the relationship was formed with the aid of the promoter 150, the consumer 130 is the merchant's “client”.

A consumer 130 may be customer of a merchant 121-125 and have no relationship to the promoter 150. A consumer 130 may be a member with respect to the promoter 150 and may have no relationship to any merchant 121-125 or may have a relationship with one or more merchants 121-125. If the relationship between the member and the merchant 121-125 were formed with the aid of promoter 150, the customer 130 would be a client of the merchant 121-125 (e.g., a client of the merchant 121-125 through the promoter 150). If the relationship between the member and the merchant 121-125 was related to a pre-existing transaction with the merchant 121-125 the member would be a customer of that particular merchant, e.g., merchant 121 (due to the pre-existing transaction therebetween) and could also be a client of other merchants , e.g., merchants 122-125, formed through the aid of the promoter 150.

As illustrated in FIG. 2, the promoter 150 maintains a merchant database 121a-125a for each merchant 121-125, respectively. The merchant database 121a-125a includes a customer database 121b-125b and a client database 121c-125c, respectively. The customer databases 121b-125b include the customer information previously maintained by the merchant 121-125 and provided to the promoter 150. The information contained therein is owned by the merchant 121-125 and may be withdrawn (e.g., extracted/removed from the system by the promoter 150) by a request of the merchant 121-125.

The client database 121c-125c for each merchant 121-125, respectively, include members of the promoter member database 155 that interacted with the respective merchant 121-125 as will be described hereinbelow.

The member database 155 includes members and potential members. Members are consumers 130 that have interacted with the promoter 150 and created a member profile in the promoter member database 155. Members may link to one or more merchants 121-125 and may connect with each merchant 121-125 through the merchant database 121a-125a (e.g., through the customer database 121b-125b and/or the client database 121c-125c) as discussed in detail hereinbelow.

The promoter 150 includes a promotion/integration/linking engine 157 that performs the various methods described herein. The promotion/integration/linking engine 157 may be any suitable computer system or computer systems that work together to perform the steps described herein. In one embodiment, the promoter includes a promotion engine 157a, an integration engine 157b and a linking engine 157c wherein the functions may be performed by a single computer or the functions could be performed by individual computer systems. In another embodiment, the functions of the integration engine 157b and linking engine 157c are performed in a centralized location (e.g., the promoter's location or other suitable centralized location) and one or more of the functions of the promotion engine 157a are performed by a remote processing system. For example, one or more tasks of the promotion engine 157a may be performed on a computer and/or a smart device at a merchant's location. The computer and/or smart device that executes as a promotion engine 157a connects through any acceptable access portal (e.g., wi-fi, internet, wireless telephone network) to one or more computer at the promoter's location.

Potential members in the promoter member database 155 are consumers 130 that have not interacted with the promoter 150. The integration engine 157b identifies potential members when a customer database 121b-125b from a merchant 121-125, respectively, is integrated into the promoter member database 155. The integration engine 157b may identify potential members during the initial integration of the merchant database 121a-125a. The integration engine 157b may also identify potential members during integration of updates and/or additions to the merchant database 121a-125a periodically provided to the promoter 150 by each of the merchants 121-125. The integration engine 157b is discussed in detail hereinbelow.

As discussed hereinabove, one or more customer 130 have a pre-existing relationship with the merchant 121-125. A member has a relationship (e.g., membership and/or subscription) with the promoter 150 and may have a relationship with one or more merchants 121-125 through the promoter 150. A client is a member that forms a new relationship with a merchant 121-125 via the promoter 150.

A consumer 130 may be customer of a merchant 121-125 and have no relationship to the promoter 150 (e.g., a potential member of the promoter 150). A consumer 130 may be a member with respect to the promoter 150 and may have a relationship with one or more merchants 121-125. If the relationship between the member and the merchant 121-125 was formed through the promoter 150, the customer would be a client of the merchant 121-125 (e.g., a client of the merchant 121-125 through the promoter 150). If the relationship between the member 121-125 and the merchant 121-125 was related to a pre-existing transaction with the merchant 121-125, the member would be a customer of that particular merchant 121-125 (due to the pre-existing transaction therebetween) and could also be a client of other merchant 121-125 formed through a relationship generated by the promoter 150.

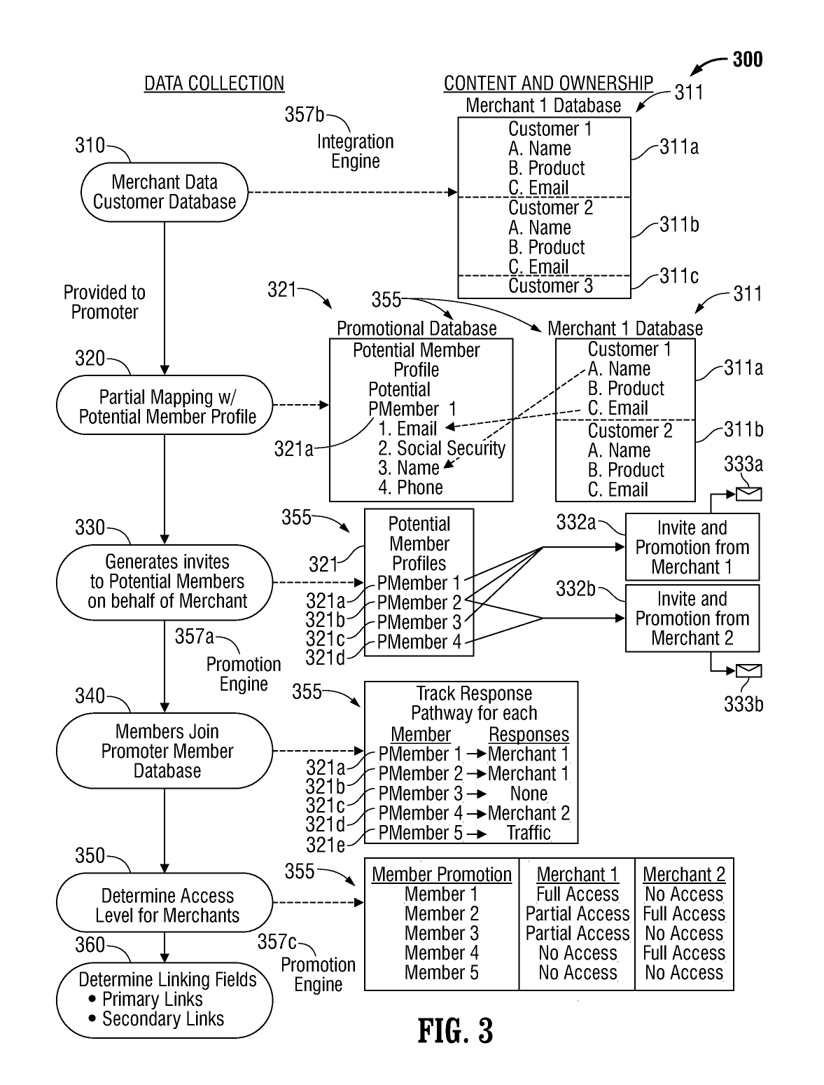

As illustrated in the database flow chart of FIG. 3, the integration engine 357b includes the integration steps of providing a merchant customer database (Step 310); partially mapping the merchant's customer database 311 with partial mapping to potential member profiles (Step 320). The promotion engine 357a includes any of the steps of generating invitations to potential members on behalf of the merchants (Step 330) and inducing invitees to join (e.g., or accept invitations to join the promoter member database 355) (Step 340). The linking engine 357c includes any of the steps of determining an access level for merchants 121-125 (Step 350) and determining linking fields (e.g., primary links and secondary links between members of the promoter member database and merchants 121-125) (Step 360).

In Step 310, the merchant customer database 311 includes individual customer entries (Customer1 311a, Customer2 311b, Costomer3 311c to CustomerX). Each customer database entry 311a-311c may include a plurality of data entries with information specific to each customer. For example, customer data entries 311a-311c may include first name, last name, a unique identifier (e.g., social security number, e-mail address or other unique identification pattern), one or more addresses (home, business and/or any portion thereof), phone number (e.g., home, work and/or cell), one or more product or service entries (related to past business transactions or potential future business transactions).

The merchant customer database 311 may include customer database entries 311a-311c specific to the merchant's business (e.g., goods, service or any combination thereof). For example, a car repair business that provides automotive services may include data entries related to the type of vehicle(s), data related to services provided (repairs, service calls, towing, estimates for repairs), data related to goods provided for a repair and/or any other suitable data entry.

In Step 320, each customer database entry 311b, 311c in the merchant customer database 311 is partially mapped to a potential member profile 321a. For example, in database Merchant1 311, Customer1 321a data entry A (name) is mapped to Pmember1 321a data entry 3 (name) and in Customer1 321a data entry C (e-mail) is mapped to Pmember1 321a data entry 1 (e-mail). Since the structure and entries of the merchant customer database 311 (provided in Step 310) are different than the structure and entries of the promoter member database 321 (generated in Step 320), mapping between the two databases will only be a partial mapping therebetween.

Partial mapping (Step 320), as illustrated in FIG. 3, may identify one or more consumers from the merchant customer database 311 who are already members of the promoter member database 355. For example, an entry in the merchant customer database 311 and an entry in the promoter member database 355 may include the same unique identifier that may only be associated with the same consumer. Examples of unique identifiers include e-mail address, social security number, alien registration number and physical pattern (e.g., facial recognition, fingerprint recognition, voice recognition, retina recognition) or other suitable pattern that may be used to uniquely identify an individual.

Integration engine 157b may generate a full link, or partial link, between the one or more consumers in the merchant customer database 311 and similarly related members of the promoter member database 355. Generation of a full link would eliminate the potential member profile 321a for the consumer in the merchant customer database 311 and would connect the existing member in the promoter member database 355 with the matching consumer in the merchant customer database 311. The full link would provide full access of the existing member profile of the member of the promoter member database 355 to the merchant. A partial link would indicate a potential relationship between the potential member profile 321a and the existing member in the promoter member database 355. The promotion engine 357b may convert a partial link to full link after the existing member in the promoter member database 355 connects with the merchant through the promoter 150.

Whether to create a partial links or to create a full link is determined by rules of the integration engine 357b (e.g., integration rules). Integration rules are determined by the promoter 150 and may be specifically structured for each merchant. For example, integration rules for one merchant may create a full link if the merchant database 311 generates a partial match on at least three fields in the promoter member database 355 (such as, for example, address, city and last name). Another set integration rules may require an exact match of at least one unique identifier and an exact match of another field such as, for example, name, address or phone number. Integration rules may generate a list that require human intervention and/or review to determine if the member in the merchant database 311 is identical to the member in the promoter member database 355.

In Steps 330, 332a and 332b, the promotion engine 357a generates invitations 333a, 333b to potential members 331a-331d on behalf of the merchants (e.g., Merchant1, Merchant2). Invitations 333a, 333b are generated and sent to the new potential members 331a-331d inviting them to join the promoter 150. The invitations 333a, 333b may include one or more promotional offers to entice the potential members 331a-331d to connect to the promoter 150 and become a member. As illustrated in Step 332a of FIG. 3, Merchant1 provides invitations 333a to potential members (e.g., Pmember1 331a, Pmember2 331b, and Pmember3 331c) defined in the promoter member database 321 and linked to Merchant1. In Step 332b Merchant2 provides invitations 333b to potential members (e.g., Pmember2 331b and Pmember4 331d) linked to Merchant2. In some instances, potential member 331b may receive invitations 333a, 333b from more than one merchant (e.g., promoter 150 sends Pmember2 331b an invitation 333a from Merchant1 and an invitation 333b from Merchant2).

The generation of invitations 333a, 333b to join the promoter 150 in response to the integration of new data into the promoter member database 321, as discussed hereinabove and illustrated by Steps 330, 332a and 332b, may be initiated and/or performed by the integration engine 357b. Alternatively, the integration engine 357b may prompt the promotion engine 357a, or generate a promotion instructing the promotion engine 357a, that results in sending invitations 333a, 333b to new potential members 331a-331d identified by the integration engine 357b.

In Step 340 potential members (e.g., Pmember1 321a, Pmember2 321b and Pmember3 321d) join the promoter member database 355. Promoter 150 tracks each invitation 333a, 333b and determine which invitation 333a, 333b successfully enticed each potential member to connect with the promoter 150 and become a member of the promoter member database 355. For example, Pmember1 331a and Pmember2 331b may responded to the invitation 333a provided by Merchant1. As such, Pmember1 331a and Pmember 2 331b became members of the promoter member database 355 and Pmember1 331a and Pmember2 331b are converted into Member1 and Member2, linked to Merchant1 as a linked “Customer” and the partial links between Merchant1 and each of Pmember1 331a and Pmember2 331b may be removed. Similarly, if Pmember4 331d responds to the invitation 333b provided by Merchant2 and becomes a member of the promoter member database 355, Pmember4 331d is converted into Member4 and linked to Merchant2 as a linked “Customer” and the partial link between Pmember4 321d and Merchant2 is removed.

In this particular example, Pmember2 331b receives invitation 333a from Merchant1 and invitation 333b from Merchant2. Pmember2 331b only responds to the invitation 333a sent from Merchant1 and does not become a member of the promoter member database 355 through Merchant2. Pmember2 331b is converted into Member2 and linked to Merchant1. Since Pmember2 (now Member2) did not respond to the invitation 333b send from Merchant2, the promoter 150 does not convert the partial link and Pmember2 331b remains partially linked to Merchant2. Promoter 150 may generate a secondary link between the newly formed Member2 and Merchant2 and promoter 150 may provide limited or partial access of Member2's profile or promoter 150 may allow Merchant2 to generate and provide information and/or advertisements to Member2.

In Step 350, the linking engine 357c determines and/or generates an access level for Merchants and in Step 360 the linking engine 357c determines and/or generates linking fields (e.g., primary links and secondary links) between Merchants and Members and between Merchants and Potential Members. As illustrated in FIG. 3, the links and partial links generated between the members of the promoter member database 355 and a Merchant define the interaction allowed between the individual member and the Merchant. Linking provides the Merchant access to the member profile, thereby allowing targeted promotion to member of the promoter member database 355. In another embodiment, linking provides continuous and/or periodic updates to the Merchant database 311 (e.g., the entry in the customer database 121b-125b or the entry in the client database 121c-125c, see FIG. 2). Updates may include identical database fields in each database, selected fields in each database or all fields from the promoter member database 355 (thereby expanding the database entry in the merchant database 311 to include all information included in the member profiles in the promoter member database 355).

Links and partial links between entries in the promoter member database 355 and entries in each merchant database 311 (e.g., merchant database 121-125, see FIG. 2) determine access and/or ownership of consumer data. Promoter 150 may use links and partial links to track data ownership through-out the integration and promotion process thereby providing a clear distinction between data owned and/or collected by each merchant, data co-owned and/or jointly collected by the merchant 121-125 and promoter 150 and data owned and/or collected by the promoter 150. In the event that a merchant 121-125 terminates the relationship with the promoter 150, the promoter 150 may extract the merchant's database 311 from the promoter member database 355 wherein the extracted data includes the original data provided by the Merchant, data derived or obtained from the original data (e.g., co-owned and/or jointed collected by the Merchant 121-125 and the promoter 150) and data obtained by the members that connect with the Merchant 121-125. As such, the promotion engine 357a, the integration engine 357b and/or the linking engine 357c, while blending a merchant database 311 into the promoter member database 355 all maintain separation between the merchant database 311 and the promoter member database 355 thereby allowing future separation of the databases 311, 355.

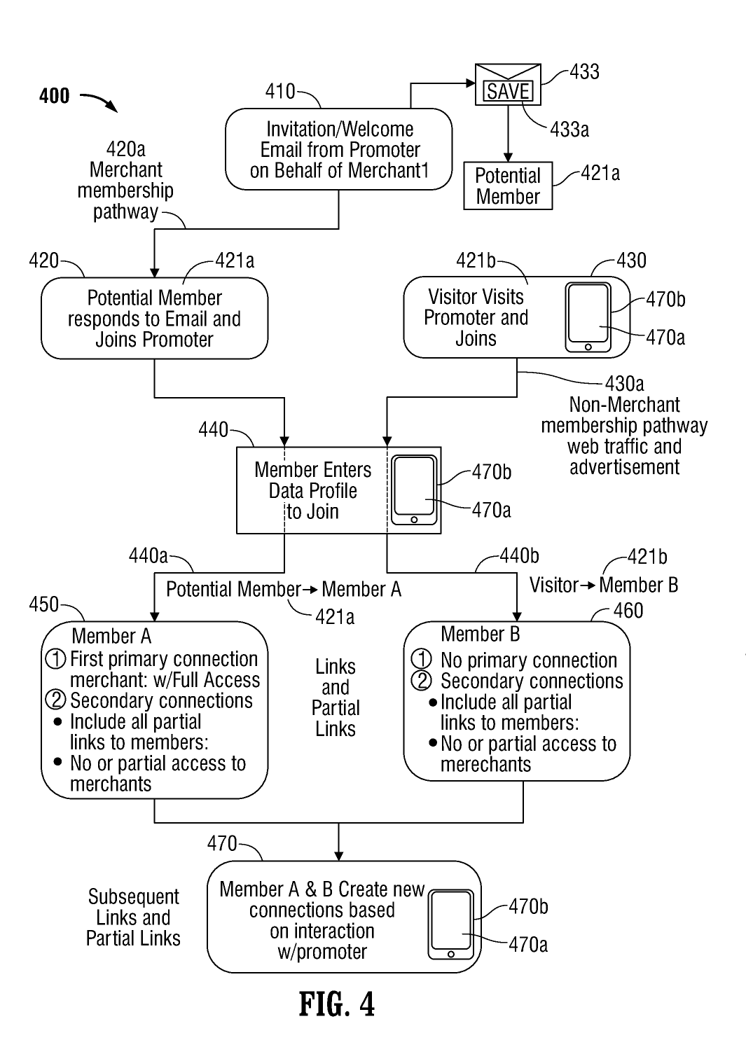

Turning now to FIG. 4, a flow chart depicting the task of member data collection by the promoter 150 and linking of the member data to a merchant is shown as 400. After integrating and/or linking a merchant database 311 (or new customer data provided by the merchant) with the promoter member database 355, the promoter 150 generates an invitation 433 (Step 410) to potential members 421a. Potential member 421a that receives the invitation 433 may also be a partially linked members (e.g., potential members 321a-321d and/or partially linked members generated during the integration of the merchant database 311 with the promoter member database 355). The invitation 421a generated in Step 410 may be sent by the promoter 150 on behalf of the merchant or the invitation 433 may be sent from the merchant as a service of the promoter 150. The invitation 433 to potential member 421a may be a welcome e-mail inviting the potential member 421a to become a member of the promoter 150.

An invitation 433 sent to potential member 421a identified as a partially linked members may inform the potential member 421a that a new merchant has joined the promoter 150. The invitation 433 may provide information about the new merchant (e.g., merchant 121-125, see FIG. 2), may indicate that the member is a past customer of a merchant 121-125 and/or may include information from any merchant database 121-125 that would indicate that the member is a past customer of the merchant (121-125). Invitation 433 may provide details related to a past transaction between a merchant 121-125 and the potential member 431a (e.g., invitation 433 recipient). For example, the invitation 433 may suggest that an automobile serviced by the merchant 121-125 and owned by the potential member 421a is due for service based on information drawn from the merchant database 121-125 partially linked to the profile of the potential member 421a.

In Step 410, if the invitation 433 is from the promoter 150 the invitation 433 may include one or more advertisements 433a that feature one or more merchants 121-125. The advertisement 433a may include a discount offer, a coupon or other financial incentive intended to entice the potential member to become a member of the promoter member database 455.

Following a merchant membership pathway 420a, a potential member 421a that response to the merchant/promoter's invitation 433 (Step 420), and completes a member profile with the promoter 150 (Step 440), is converted from a potential member 421a to a member of the promoter member database 455 (e.g., MemberA) and linked to the merchant 121-125 (Step 450). The conversion of the potential member 421a to a MemberA (Step 450) may also generate partial links between other merchants and the member based on a comparison between the data entered by MemberA and data contained in other merchant databases 121-125. For example, during registration (Step 440), MemberA may provide an e-mail address and a first merchant and a second merchant (e.g., any of merchant 121-125) may have provided the same e-mail address to the promoter 150. Upon discovery of the matching e-mail addresses the promotion engine (see promotion engine 357a) may promoter 150 may generate a two separate potential member profiles (first potential member profile and second potential member profile) with the same e-mail address. The promoter 150 may send a first invitation 433 from the first merchant (under the first potential member profile) and may also send a second invitation (not specifically shown) from the second merchant with each invitation indicating that the respective merchant is also connected to the promoter 150. If the potential member 421a responses to the first invitation 433, the first potential member profile is converted to a MemberA and the first merchant is linked to MemberA as a first primary connection with full access to the MemberA profile in the promoter member database 455. The second merchant may be partially linked to MemberA (due to the same e-mail address) or the second merchant may be partially linked to the member profile through the second potential member profile as a secondary connection (no or partial access).

Alternatively, the promoter 150 may provide a single invitation 433 to the potential member 421a indicating that the first and second merchants (e.g., any two of merchants 121-125) are also connected to the promoter 150 and responding to the invitation 433 may generate a primary connection between the MemberA and the first and second merchants.

In Step 470 members (e.g., MemberA, MemberB) of the promoter member database 455 may access merchants 121-125 through the promoter portal 470a. The promoter portal 470a may be a web site or an application configured to execute and run on a portable smart device 470b. The promoter portal 470a provides the members (e.g., MemberA, MemberB) with offers from merchants 121-125 linked to the member (e.g., MemberA, MemberB). The member may also link to merchants 121-125 by interacting with merchants 121-125 on the promoter portal 470a. For example, a MemberA may be linked to a first and a second merchant, partially linked to a third merchant and no connection with a fourth merchant. MemberA is presented with discount offers and/or information from the first and second merchant upon entering the promoter portal 470a due to the existing link therebetween. MemberA may elect to accept the discount offer and/or information from the first and/or second merchant or MemberA may elect to search (and/or browse) in a particular category and thereby interact and link to new (e.g., other) merchants (e.g., previously partially linked merchants, such as the third merchant, or other unlinked merchants, such as the fourth merchant.

In one embodiment, a partial link may provide preferential treatment to the partially linked merchant (See Step 350, Member1 and Member2 with a partial link/access to Merchant1). For example, a search in the promoter portal 470a in a particular category may provide a list of merchants (e.g., Merchant 1) wherein the partially linked merchant (e.g., Merchant1) is listed as the first entry in the search results.

In Step 430 visitor 421b visits the promoter portal 470a through a smart device 470b (e.g., any suitable access device) and may join the promoter 150 without receiving an invitation from a merchant. Visitor 421b joining via the non-merchant membership pathways 430a may be generated through general web traffic, invitations independently generated by the promoter 150 and unrelated to a particular merchant (e.g., mass mailings), invitations generated through social media advertisements and interactions, invitations generated by current members and any other traditional methods of generating traffic to the promoter portal 470a. In Step 440 the visitor 421b becomes MemberB by generating a profile and becoming a member of the promoter member database 455. Initially, as indicated in Step 460, the MemberB is not linked to any merchants although the promoter 150 may generate partial links between MemberB and merchants 121-125. The partial-links may be related to matches (or partial matches) of information provided by MemberB and information contained in the merchant databases 121a-124a. For example, the first and last name of MemberB may match a member of a merchant database 121a-125a and the e-mail provided by MemberB may be substantially identical (e.g., two letters are transposed and presumably incorrect) to a member of a merchant database 121-125. The promoter 150, by comparing the information provided by MemberB and the information provided in the Merchant databases 121a-125a, may generate one or more partial links between the MemberA and one or more of the merchants 121-125, thereby providing partial access or limited access to the partially linked merchants 121-125.

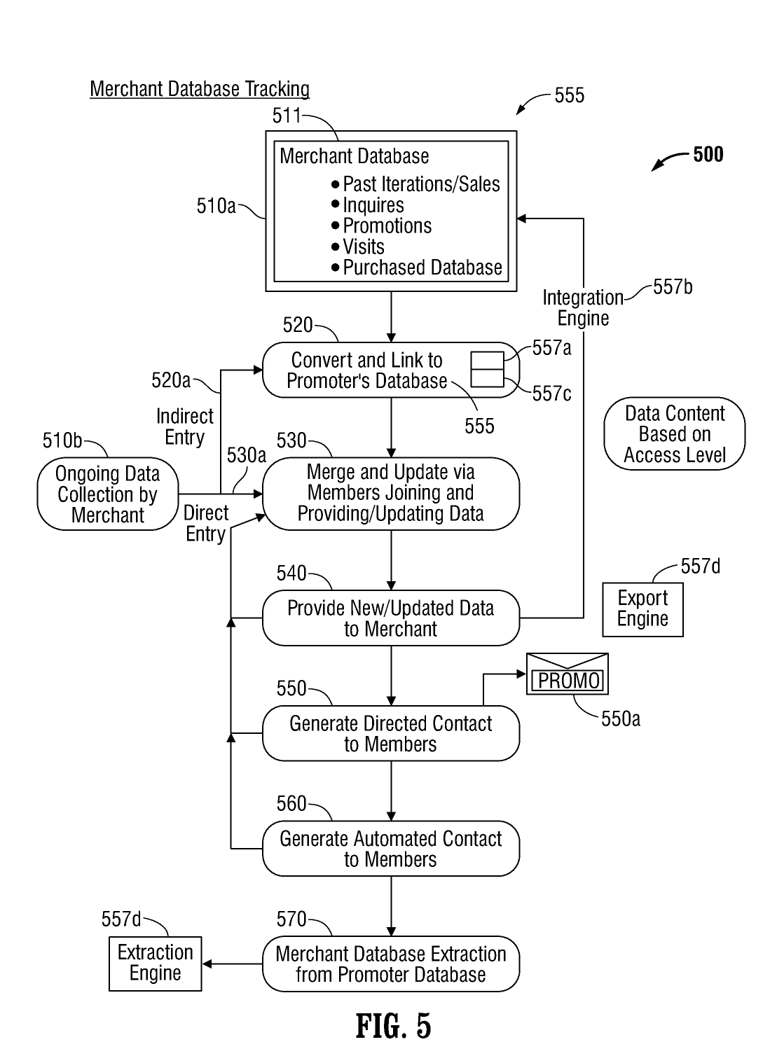

In FIG. 5, a flow chart depicting merchant database 511 tracking with respect to the promoter member database 555 is shown as 500. Merchant data is provided to the promoter 150 as a merchant database 511 (Step 510a) or ongoing data (e.g., new customers or updates to existing customers) may also be collected by the merchant (Step 510b). The merchant database 511 includes a plurality of individual customer database entries generated through past interactions (e.g., providing sales and/or services), inquiries by individual customers, information received through promotions and/or visits or information purchased from an external data source. The merchant database 511 is converted by the integration engine 557b (discussed hereinabove) and linked to the promoter member database 555 (Step 520) by the integration engine 557a and/or linking engine 557c. Ongoing data collected may be provided directly 530a to the promoter member database 555 or indirectly entered 520a through the conventional merchant database 511 integration and linking pathway (e.g., integration engine 557b and/or linking engine 557c, Step 520). In Step 530 the promoter member database 555 is updated, joined, merged and linked as new merchant data is inputted and/or updated or new members join the promoter 150 through the acceptance of invitations (See FIGS. 3 and 4) or through member interaction through the promoter portal 470a (Steps 550 and 560).

Merchants may request an export (Step 540) or extraction (Step 570) of their customer database (Step 540) by requesting their customer database. Export engine 557 may be utilized to export the database. Exports may be automatically generated wherein the merchant only receives a copy of their merchant database 511 extracted from the promoter member database 555. The automated request sent to the export engine 557 for an export may be time based or event based and may include the entire merchant database 511 or any portion thereof. Export engine 557 may also generate a merchant database 511 export based on an event or preselected occurrence, as discussed in greater detail hereinbelow.

Customer database extractions (Step 570) remove the merchant database 511 from the promoter member database 555 thereby terminating the relationship between the merchant and the promoter 150. Extraction Engine 557d extracts the merchant database 511 from the promoter member database 555 and provides the merchant with the original merchant database (see FIG. 3, merchant database 311) initially provided to the promoter 150 with any additional data obtained by the promoter 150 through use of the data contained in the merchant database 311. For example, new data obtained by utilizing data contained in the original merchant database 311 is provided to the merchant through the extraction step (Step 570).

In one embodiment, the extraction engine 557d permits the promoter 150 to retains the portion of the merchant database 511 that was further developed by the promoter 150. For example, as illustrated in FIG. 4, promoter 150 sent an invitation to potential member 421a on behalf of the merchant. Potential member 421a accepted the invitation and, though the promoter portal 470a potential member 421a became MemberA in the promoter member database 555. In this example, promoter 150 and merchant retains the information related to Member. MemberB, who joined the promoter member database by accessing the promoter portal 470a, is not linked to the merchant therefore the extraction engine 557d does not provide any information related to MemberB. Extraction engine 557d provides at least a portion of the new information obtained by the promoter 150. For example, extraction engine 557d provides any information provided to the promoter 150 when MemberA joined the promoter 150 (e.g., promoter 150 obtained this information through use of the information provided in the Merchant database 511).

Promoter portal 570a provides tools for the merchant 121-125 to generate and send promotional material, advertisements, discount cards/coupons and/or other suitable mailing to the promoter members and/or merchant's customers (e.g., promotional materials 550a). Merchant 121-125 may dynamically create promotional materials 550a such as documents, coupons, newsletters and surveys to send to their customers. Tools may also provide the ability to upload content and graphics such as logos, pictures and text. Promoter portal 570a provides templates for use in generating documents and content. Document and content may be stored within the promoter portal 570a for backup and for future use.

In embodiments, the merchant 121-125 may be limited to sending promotional material 550a to members linked to the merchant 121-125.

In embodiments, the merchant 121-125 may define the demographical profile of the members in the promoter member database 555 and may generate and send promotional materials 550a to the members. Members may be linked members, linked and partially linked members in the promoter member database 555.

In embodiments, the merchant 121-125 may define the demographical profile of the members in the promoter member database 555, generate and send promotional materials 550a but the identity of the members that receive the promotional materials 550a are not be provided to the merchant 121-125 unless the members accessed the promoter portal 570a and interfaced with the merchant 121-125 (thereby linking to the merchant 121-125, see Step 470).

In embodiments, the merchant 455 may generate an automated promotional materials 550a, wherein the sending of the promotional materials 550a is triggered by a specified, yet currently unknown, event. For example, promotion materials 550a may be generated by the merchant 121-125 wherein the promotional materials will be sent when a specific event occurs, such as, for example, a weather event, a sporting event, a political event, a entertainment event, a financial event, or any other suitable outcome based event.

Merchant 121-125 may set specific rules that, when met, automatically send promotional materials 550a wherein the rules may be related to any specific event. Examples include birthdays, anniversaries, events related to date from external system (e.g., weather, sports, stock market events, local events, political outcomes, results of local sporting events, entertainment events such as motion picture releases and award presented for various entertainment accomplishments, probability events, such as chance of rain, snow or sunshine, or social media event such as trending information or information posted on other social media locations.

An example for generating promotional materials based on the outcome of an event can be illustrated in FIGS. 3-5. Promoter member database 355 including a plurality of member database entries and a merchant database 311. The merchant database 311, received from a merchant and integrated into the promoter member database 355, includes a plurality of individual customer entries. The linking engine 357c and/or the integration engine 357b generates a plurality of links defining common information contained in the plurality of individual customer entries and the plurality of member database entries. Links may be partial links that provide the merchant with partial access to a member or links may be primary/secondary links that provide the merchant with full access to a member.

The promoter portal 470a may be used to generate promotional material 550a. The promoter portal 470a may also be used to define criteria for selecting recipients. The recipients are selected from the plurality of promoter member database 355. The promoter portal 470a is used to define a trigger for releasing the promotion material 550a. The plurality of links may be used to determine the selected recipients based on the defined criteria.

The promotion engine 357a determines when the trigger has occurred and, upon occurrence of the trigger, sends the promotional material to the selected recipients. The trigger may be related to the outcome of a specific event. The content of the promotion may be a function of the outcome of the specific event. For example, the trigger may be the conclusion of a sporting event between Team A and Team B. Separate promotional material 550a may be prepared for the three possible outcomes, namely, the first outcome being Team A winning, the second outcome being Team B winning and the third outcome being a tie between Team A and Team B. In the event of the first outcome, promotional materials 550a are sent to first group of recipients inviting them to celebrate the win of Team A and a second group of recipients inventing them to join a loss support group for Team B. In the event of the second outcome, promotional materials 550a are sent to first group of recipients inviting them to celebrate the win of Team B and a second group of recipients inventing them to join a loss support group for Team A. In the event of the third outcome, promotional materials 550a may be sent to all recipients inviting them to attend the next meeting and rematch between Team A and Team B.

As demonstrated in this example, the criteria for selecting recipients may be a function of the outcome of the specific event. Promotional material 550a directed to the winning team are sent to supporters of Team A or Team B depending on the outcome. Promotional materials 550a directed to the loosing team are sent to supporters of Team A or Team B depending on the outcome. Finally, the same promotional materials 550a may be sent to supporters of both team in the event of a tie between Team A and Team B.

The outcome of the specific event may define the criteria for selecting recipients. For example, if the specific event is related to weather, an outcome of snowfall may define recipients as being downhill skiers and/or snowmobilers and the promotional material 550a may be related to skiing and/or snowmobiling. Another outcome of an outdoor temperate exceeding a threshold may define recipients as beach-goers and/or boaters and the promotional material 550a may be related to outdoor activities. The outcome of a political event such as the issuance of an executive order limiting the sale of a particular article may define recipients as purchasers of the particular article and the promotional material 550a may be related to discounts on the particular article. Finally, the outcome may be a financial event may define recipients as individuals affected by the financial event and the promotional materials 550a may be directed to assistance for the individuals affected by the financial event.

A method related to generating promotions includes the steps of providing a promoter database including a plurality of member records; defining a trigger for automatically generating a promotion(s); defining at least a portion of the plurality of member records for receiving the promotion(s); determining when the trigger occurs; and sending a promotion(s) to the defined portion of the plurality of member records. The trigger may be related to an outcome of a specific event, wherein content of the promotion is a function of the outcome of the specific event. As discussed hererinabove, the specific event may be a weather event, a sports competition, a political event, an entertainment event, a financial event, etc.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A system for integrating customer databases, the system including:
a merchant database received from a first merchant, the merchant database including a plurality of individual customer entries;
a database provided by a promoter;
an integration engine for integrating the merchant database with the promoter database, the integration engine configured to maintain a differentiation between the merchant database and the promoter database;
a promotion engine configured to obtain additional information relating to each of the plurality of individual customer entries; and
an extraction engine configured to extract an extraction database from the promoter database, wherein the extraction database includes the merchant database and the additional information relating to each of the plurality of individual customer entries obtained by the promotion engine.

2. The system according to claim 1, wherein the promotion engine generates a plurality of individual customer entries in the promoter database, wherein at least one of the plurality of individual customer entries includes information related to data provided in the merchant database.

3. The system according to claim 2, wherein the integration engine differentiates between information contained in the promoter database and each of the plurality of individual customer entries.

4. The system according to claim 1, wherein the promotion engine is configured to generate electronic invitations from data contained in the merchant database, wherein the electronic invitations invite each of the plurality of individual customer entries to accept the invitation and join the database provided by the promoter.

5. The system according to claim 1, further including:
a linking engine configured to generate links between data contained in an individual customer entry of the merchant database and data contained in the database provided by the promoter.

6. The system according to claim 5, wherein the promotion engine is configured to generate an electronic invitations related at least one link generated by the linking engine wherein the electronic invitations invite an individual customer entries in the merchant database to accept the invitation and join the database provided by the promoter.

7. A method for integrating customer databases, the method including the steps of:
providing a database from a promoter including a plurality member records;
providing a first merchant database and a second merchant database, wherein each of the first and second merchant databases includes a plurality of customer entries;
integrating the first merchant database and the second merchant database with the promoter database while maintaining the individual integrity of the promoter database and the first and second merchant databases;
obtaining information related to at least one of the plurality of customer entries in the first merchant database;
extracting an extraction database from the promoter database wherein the extraction database includes the first merchant database and at least a portion of the obtained information.

8. A method of automatically generating promotions, the method including the steps of:
providing a promoter database including a plurality of member records;
defining a trigger for automatically generating a promotions;
defining at least a portion of the plurality of member records for receiving the promotion;
determining when the trigger occurs; and
sending a promotion to the defined portion of the plurality of member records.

9. The method according to claim 8, wherein the trigger is related to the outcome of a specific event, wherein content of the promotion is a function of the outcome of the specific event.

10. The method according to claim 9, wherein the specific event is a weather event.

11. The method according to claim 9, wherein the specific event is a sports competition.

12. The method according to claim 9, wherein the specific event is a political event.

13. The method according to claim 9, wherein the specific event is an entertainment event.

14. The method according to claim 9, wherein the specific event is a financial event.

15. A system for generating promotional materials, the system including:
a database provided by a promoter, the database including:
a merchant database received from a first merchant, the merchant database including a plurality of individual customer entries;
a plurality of member database entries; and
a plurality of links defining common information contained in the plurality of individual customer entries and the plurality of member database entries;
a promoter portal for generating promotional material, defining criteria for selecting recipients wherein the recipients are selected from the plurality of member database entries, defining a trigger for releasing the promotion material; and
a promotion engine configured to determine when the trigger has occurred and, upon occurrence of the trigger, sending the promotional material to the selected recipients.

16. The system according to claim 15, wherein the trigger is related to an outcome of a specific event and content of the promotion is a function of the outcome of the specific event.

17. The system according to claim 16, wherein the criteria for selecting recipients is a function of the outcome of the specific event.

18. The method according to claim 17, wherein the specific event is at least one of a weather event, a sports event, a political event, an entertainment event and a financial event.
